(19) United States
(12) Patent Application Publication
(10) Pub. No.: US 2025/0319405 A1
(43) Pub. Date: Oct. 16, 2025

(54) SYSTEM FOR ENABLING VIEWER INTERACTIVITY WITH LINEAR MEDIA

(71) Applicant: Sony Interactive Entertainment Inc., Tokyo (JP)

(72) Inventors: Jonathan Urbanus, San Mateo, CA (US); Jackqueline Nguyen, San Mateo, CA (US); Warren Benedetto, San Mateo, CA (US)

(21) Appl. No.: 18/633,309

(22) Filed: Apr. 11, 2024

(51) Int. Cl. A63F 13/65; A63F 13/44; A63F 13/533; A63F 13/80

(52) U.S. Cl. CPC A63F 13/65; A63F 13/44; A63F 13/533; A63F 13/80

(57) ABSTRACT

To enable viewers of a game show (or any linear media program) to play along in real time, an end-to-end system connects the showrunner and players of the game show with the players at home, in real time, to create an enjoyable approach to interactivity.

### FIELD

The present application relates generally to systems for enabling viewer interactivity with linear media.

### BACKGROUND

Game shows have been a fixture in living rooms since the dawn of television, and their popularity continues on streaming services. Many game shows have been turned into games that viewers can play at home, such as board games, video games, and mobile games. However, viewing of the game shows themselves is still a passive experience. Viewers watch players on TV play the games, with no ability to play along with the game show in real time from home.

### SUMMARY

To enable viewers of a game show (or any linear media program) to play along in real time, an end-to-end system connects the showrunner and players of the game show with the players at home, in real time, to create an enjoyable approach to interactivity. While game shows are an example use-case, present principles can be used for any type of linear media (movies, TV, music, podcasts, etc.) where viewers or listeners are offered the opportunity to “play along” with the media in real time.

Accordingly, method includes receiving linear media in the form of a game show and receiving metadata with the linear media. The method also includes using the metadata for presenting at least one objective on a remote player device. Also, the method includes receiving a response to the objective, and based on the response being correct, presenting a first indication on the remote player device. Based on the response being incorrect, the method includes presenting a second indication on the remote player device.

The method can include determining whether the response is correct based at least in part on a timer, and/or based at least in part on the response matching a ground truth response contained in the metadata. In the latter case, the method can include executing at least one machine learning (ML) model to determine whether the response matches the ground truth response contained in the metadata.

In some embodiments the method can include presenting the linear media on the remote player device and synchronizing presentation of the linear media on the remote player device with presentation of the objective, such that the objective is presented at the same time in the linear media and on the remote player device. In non-limiting implementations, the method can include assessing a penalty responsive to a determination that the response is incorrect and/or awarding a reward responsive to a determination that the response is correct.

In an example embodiment, the method may include notifying a showrunner sourcing the linear media of play input via the remote player device.

In another aspect, a processor system is configured to present a live or prerecorded game show on at least one remote player device. The system also is configured to present on the remote player device at least one objective of the game show as the objective is being presented in the game show. Further, the processor system is configured to receive a response to the objective at the remote player device, and using criteria used in the remote game show, determine whether the response is correct. The processor system is configured to present an indication on the remote player device consistent with the determination of whether the response is correct.

In another aspect, a device includes at least one computer memory that is not a transitory signal and that in turn includes instructions executable by at least one processor system for receiving linear media, receiving metadata with the linear media, and using the metadata, presenting information on a display of a remote player device allowing a user of the remote player device to interact with the linear media.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 illustrates an example game show architecture;

FIGS. 3 and 4 illustrate example showrunner logic in example flow chart format;

FIG. 5 illustrates an example screen shot consistent with present principles;

FIG. 6 illustrates example initiation logic in example flow chart format;

FIG. 7 illustrates an example judge selection screen;

FIG. 8 is an example screen shot of a leaderboard;

FIGS. 9-13 illustrate example screen shots for remote game play consistent present principles;

FIG. 14 illustrates example ML model training logic in example flow chart format;

FIG. 15 illustrates example detailed logic in example flow chart format;

FIG. 16 illustrates example advertisement push logic consistent with present principles; and

FIG. 17 illustrates an example screen shot consistent with FIG. 16.

### DETAILED DESCRIPTION

This disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, extended reality (XR) headsets such as virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single- or multi-chip processor that can execute logic by means of various lines such as address lines, data lines, and control lines and registers and shift registers. A processor including a digital signal processor (DSP) may be an embodiment of circuitry. A processor system may include one or more processors.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

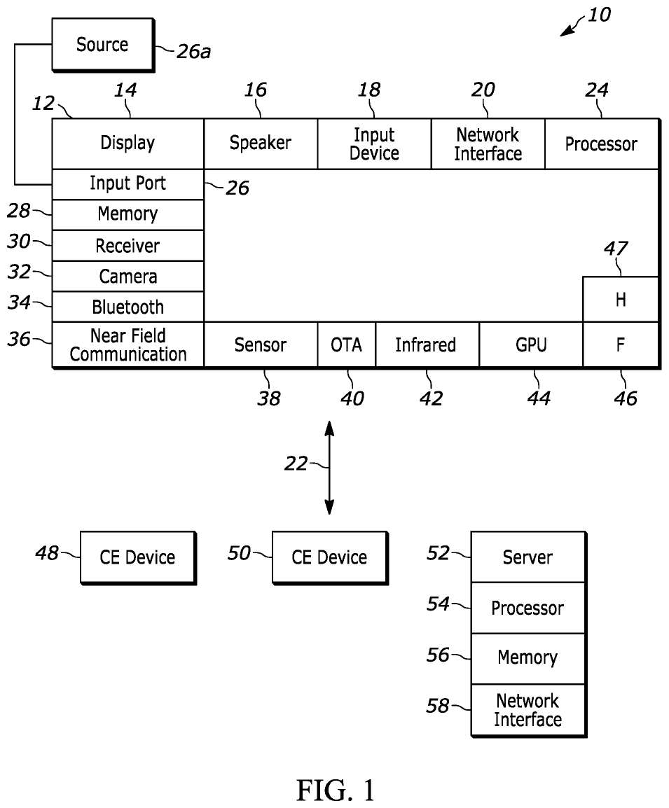

Referring now to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to a theater display system which may be projector-based, or an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories/computer-readable storage media 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24.

Continuing the description of the AVD 12, in some embodiments the AVD 12 may include one or more cameras 32 that may be a thermal imaging camera, a digital camera such as a webcam, an IR sensor, an event-based sensor, and/or a camera integrated into the AVD 12 and controllable by the processor 24 to gather pictures/images and/or video in accordance with present principles. Also included on the AVD 12 may be a Bluetooth® transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc. Other sensor examples include a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command). The sensor 38 thus may be implemented by one or more motion sensors, such as individual accelerometers, gyroscopes, and magnetometers and/or an inertial measurement unit (IMU) that typically includes a combination of accelerometers, gyroscopes, and magnetometers to determine the location and orientation of the AVD 12 in three dimension or by an event-based sensors such as event detection sensors (EDS). An EDS consistent with the present disclosure provides an output that indicates a change in light intensity sensed by at least one pixel of a light sensing array. For example, if the light sensed by a pixel is decreasing, the output of the EDS may be −1; if it is increasing, the output of the EDS may be a +1. No change in light intensity below a certain threshold may be indicated by an output binary signal of 0.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

A light source such as a projector such as an infrared (IR) projector also may be included.

In addition to the AVD 12, the system 10 may include one or more other CE device types. In one example, a first CE device 48 may be a computer game console that can be used to send computer game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player or a head-mounted display (HMD) worn by a player. The HMD may include a heads-up transparent or non-transparent display for respectively presenting AR/MR content or VR content (more generally, extended reality (XR) content). The HMD may be configured as a glasses-type display or as a bulkier VR-type display vended by computer game equipment manufacturers.

In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby.

The components shown in the following figures may include some or all components shown in herein. Any user interfaces (UI) described herein may be consolidated and/or expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Generative pre-trained transformers (GPTT) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network/artificial intelligence model trained through machine learning may thus include an input layer, an output layer, and multiple hidden layers in between that are configured and weighted to make inferences about an appropriate output.

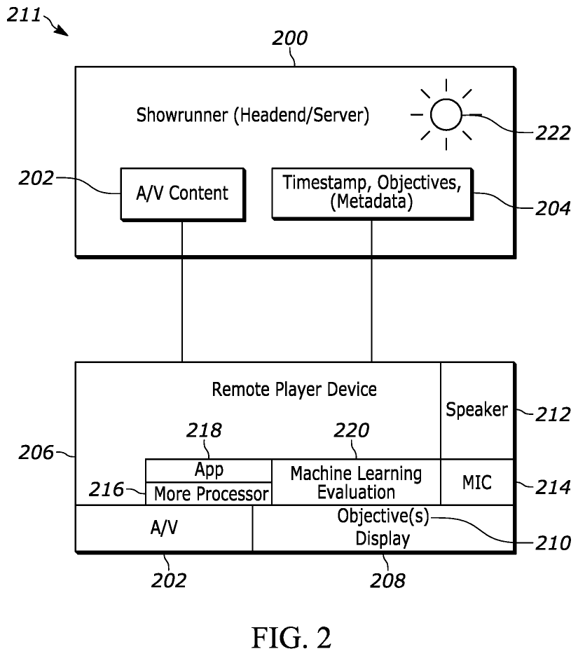

Refer now to FIG. 2 which illustrates an example system for enabling viewer interactivity with linear media. Generally, “linear media” refers to content such as audio-video content that is selected by a publisher, referred to herein as a “showrunner”, to be consumed, and is then done so, typically passively. The term is typically used in reference to programmed broadcasting.

The system in FIG. 2 includes the following component. A showrunner source 200 may be implemented by a cable or satellite headend or Advanced Televisions System Committee (ATSC) 3.0 transmitter that may include one or more server computers. The source 200 sends, typically by broadcast, AV content 202 and metadata 204 associated with the AV content to one or more receivers 206, labeled in FIG. 2 as a remote player device. The AV content and metadata may be sent over-the-air and/or over-the-top when ATSC 3.0 is used.

The showrunner system allows the executive producer or other showrunner of a linear media production to input the data with which both players on the show and viewers at home will interact. With this in mind, in some embodiments the metadata 204 may include some or all of the following data, in addition to timestamps of events in the show such as when a contestant in the AV content makes a selection or a question or puzzle is presented in the AV content.

The metadata 204 may include one or more objectives such as a question to answer, a puzzle to solve, a task to complete, etc. Also, the metadata 204 may include success conditions such as the “right” answer, the solution to the puzzle, the task completion criteria, etc. There may be one or more success conditions. Success conditions may be combined with other factors such as time, e.g. the person who gets the right answer fastest or in the fewest number of tries wins. Also, the metadata may include failure conditions such as the “wrong” answer, or it may be the failure to achieve the success condition in a certain amount of time, within a certain amount of guesses, etc. Further, the metadata 204 may include rewards and/or penalties. There may be a reward for successfully achieving the success condition, for example the awarding of points, money, extra turns, etc. Likewise, there may be a penalty for meeting failure conditions, for example the loss of points, money, turns, etc. Additionally, the metadata may include a time to complete or other time condition, defining a period in which the player must achieve success before time runs out. Also, the metadata 204 may include counters to track how many guesses the player has made and how many remain.

The metadata can be used to power the game on the set of the show during filming. For example, the system can be used to display the categories, answers, and point values on a board, and to evaluate the answers given by the players on set.

The remote player device 206 may be any appropriate device described herein, such as a tablet computer, smart phone, etc. that enables a remote player of a game embodied in the AV content to play along as the game is being broadcast. The device 206 may include a display 208 such as a touchscreen display that presents the AV content 202 as shown along with one more objectives 210 carried in the metadata 204. The device 206 may also include one or more speakers 212, one or more microphones 214 for picking up spoken commands and selections by the player, and one or more processor systems 216 executing an application (“app”) 218 consistent with disclosure herein to enable functionality consistent with present principles. The app 218 may be downloaded from, e.g., the showrunner source 200. The processor system 216 also may execute one or more machine learning (ML) models 220 for evaluating responses of the player as described further below. The ML model 220 evaluates the player input, compares it to success/fail criteria, and awards points accordingly.

The system of FIG. 2 synchronizes the delivery of the objectives with a timecode for a linear video and/or audio recording. This allows player viewers operating remote player devices 206 to be sent objectives at the same time as the contestants on the show are presented the objectives, with the same amount of time to answer, regardless of whether the show is being watched live or recorded.

The showrunner source 200 can prompt the objective to a remote player device 206 via a web application programming interface (API) during watching of the linear recording, in synchrony with the timecode, and a user interface (UI) is presented on the remote player device 206 that displays the objective to the remote player and allows the remote player to input an answer, optionally with a countdown time. The input may be text, speech-to-text, audio, video, image, etc.

In addition to the above, a cloud-based system can keep track of each player's score (per game and all-time) and can display a leaderboard on the remote player devices. The cloud-based system can receive indications of remote player achievements from the individual remote player devices 206. The showrunner may be notified of especially skilled players, allowing the showrunner to invite those players to play on the show itself. To this end, when a user of a remote player device 206 achieves a noteworthy milestone or goal, an indication of such may be provided to the showrunner source. One example of such an indication may be a blinking light 222.

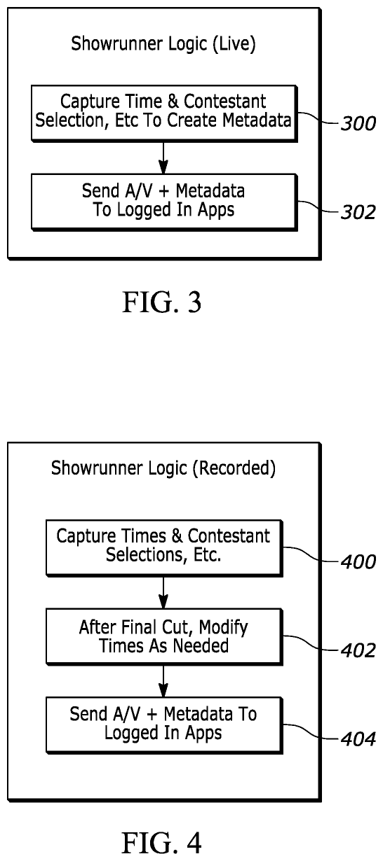

FIGS. 3 and 4 illustrate example showrunner logic. Commencing at state 300 in FIG. 3, contestant selections and objectives and times of entries of each are captured to establish portions of the metadata 204 shown in FIG. 2. The metadata is sent to logged-in apps 218 of remote players devices along with the AV content at state 302. This association between objectives and timecodes enables viewers at home to play along as they watch.

FIG. 4 illustrates the situation when the linear media is not broadcast live but rather is pre-recorded. Commencing at state 400 in FIG. 4, contestant selections and objectives and times of entries of each are captured to establish portions of the metadata 204 shown in FIG. 2. Moving to state 402, to ensure that the recording of the show has accompanying metadata which indicates which objective was selected by which player at which timecode in the recording (and assuming the show is edited for later broadcast), this metadata is amended to reflect the timecodes of the edited sequences once the final cut of the show is completed. During viewing by a remote player device 206 the metadata is sent to logged-in apps 218 of remote players devices along with the AV content at state 404.

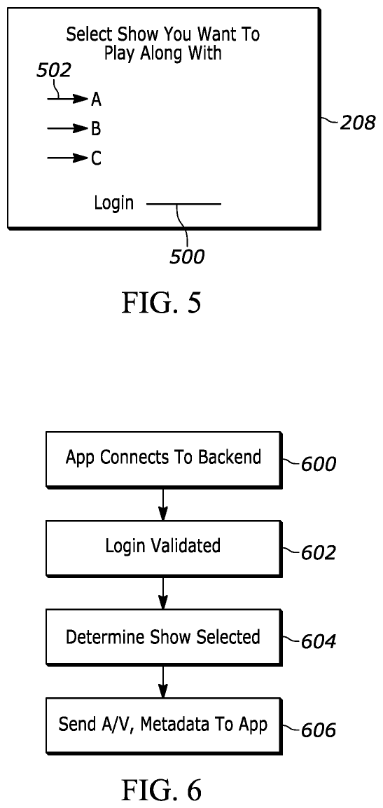

FIG. 5 illustrates a login UI that may be presented on the display 208 of a remote player device 206 who wishes to play along at home with linear media embodied as a game show. It is to be understood that the UI in FIG. 5, like the UIs of successive figures, may also present a window showing linear media as well as objectives, etc. indicated in the metadata. A login field 500 may be provided for the player to enter credentials. Also, one or more selectors 502 may be provided for the player to select the linear media the player wants to play along with. Turning to FIG. 6, selection of show “A” from FIG. 5 causes the app 218 to connect at state 600 via an API to a backend service. Login credentials are validated at state 602. State 604 indicates that the backend determines which show and episode selected, associating the remote player device 206 with that show/episode to send the show and metadata to the remote player device app at state 606.

Once connected, the app 218 displays the same objectives that are seen by the contestants on the show, in synchrony with the timecode of the show. So, if a player makes a selection at time 03:45, the showrunner source 200 transmits the metadata 204 about that objective to the viewer's app 218 via a viewer prompting API. The app then displays the same information to the viewer that the contestant on the show received, at the same time.

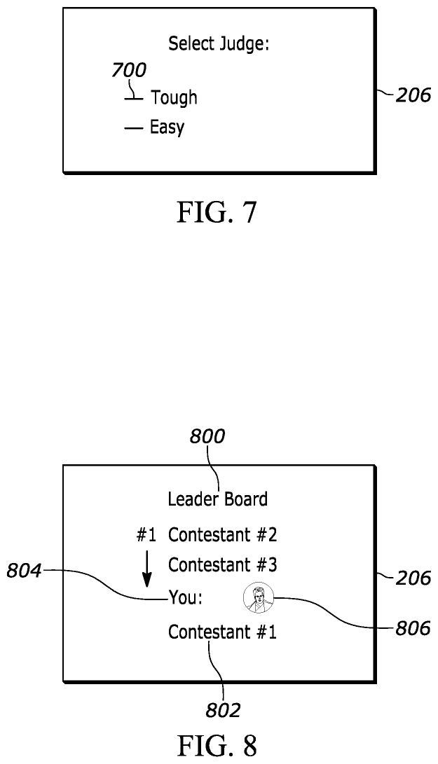

FIGS. 7 and 8 illustrate UIs that can be presented on the remote player device 206, audibly and/or visibly like the other UIs herein. The remote viewer's response to a question should be evaluated relative to success or failure conditions to determine whether the remote viewer guessed correctly. Such a system may simply compare the viewer's text input to the success criteria to see if it matches. However, when a ML evaluation model 220 is implemented, the remote player's responses may be compared to the ground truth correct response received in the metadata 204 in degrees. FIG. 7 enables a player to select the difficulty of the “judge” of the player's answer using selectors 700. That is, input can be evaluated by the ML evaluation model 220 in FIG. 2 on a similarity scale to determine whether it is “close enough.” For example, a viewer might input “A and B,” which the ML model may determine is only 50% similar to the correct answer. If a “judge” is selected with a correctness threshold of 90%, the answer would not considered to be correct, but if a “judge” is selected with a correctness threshold of 49%, the answer is considered correct.

FIG. 8 illustrates a leaderboard 800 listing both contestants 802 on the show and one or more remote players 804. An image 806 of the remote plater may be presented on the leaderboard and/or inserted into the AV content. To construct the leaderboard 800, points won by the remote player can be passed to a cloud-based system which tracks the player's score for the episode, as well as other statistics such as success/failure ratio, total points, etc. that can be ranked relative to other contestants and/or remote players who played the same episode or the same show.

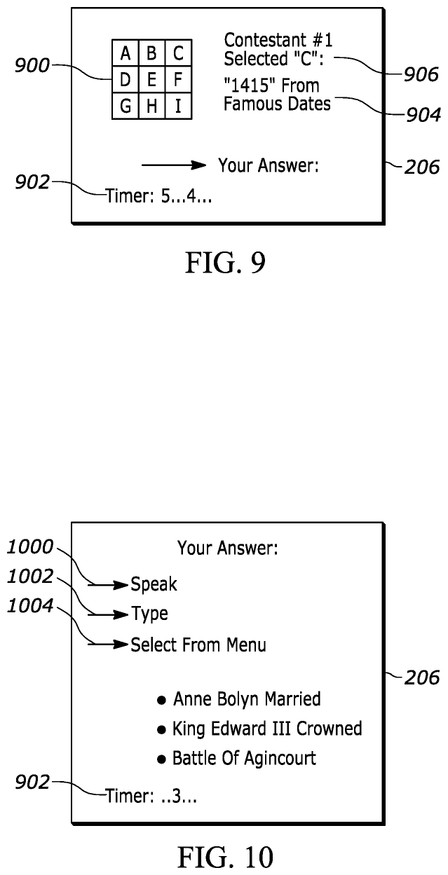

FIGS. 9 and 10 illustrate additional example UIs that may be presented on remote player devices 206. In FIG. 9, an image 900 of a game board is presented in the AV content received from the showrunner source 200 in FIG. 2. Based on the metadata 204 received from the showrunner source 200, a timer 902 may be presented so that the player knows how much time is left to answer. An example objective 904 may be presented along with information 906 as to which contestant in the show selected the objective 904. A prompt 908 for the remote player to respond to the objective may be presented. In the example shown, the objective is to guess what famous event occurred in the year 1415.

FIG. 10 illustrates a UI that can be presented to allow the remote player to select to respond verbally (selector 1000), by typing in the answer using a key entry device of the remote player device 216 (such as any of the devices discussed in relation to FIG. 1) (selector 1002), or by selecting a choice from a menu (selector 1004). One of the entries in the menu is the correct answer as indicated by the metadata 204, whereas audio (converted to text) and text input may be evaluated for correctness by the ML model 220. The timer 902 may also appear.

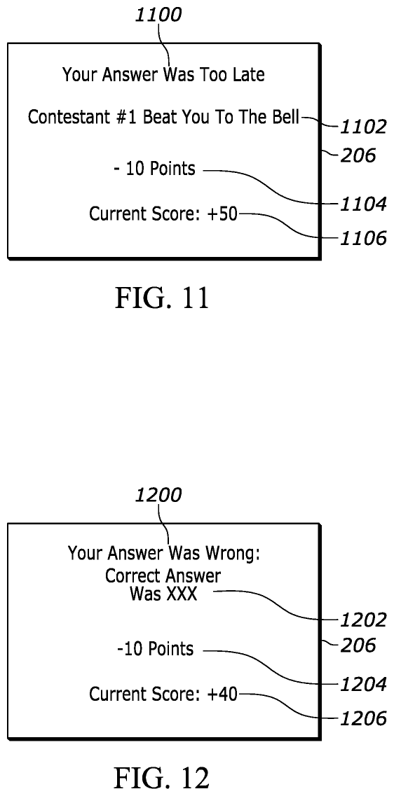

FIGS. 11-13 illustrate further UIs that may be presented to a remote player to inform the remote player of success or failure. In FIG. 11, the player took too long to respond as indicated at 1100. An advisory 1102 also may be presented as to which contestant for example in a game show responded first, it being understood that the timer limitation hence may be a set period (e.g., ten seconds) or conditional period (e.g., first answer wins). A penalty 1104 may be assessed and the player's current overall score 1106 updated.

In FIG. 12, the player's response is determined to be incorrect as notified at 1200. The correct answer 1202 may be presented. A penalty 1204 may be assessed and the player's current overall score 1206 updated.

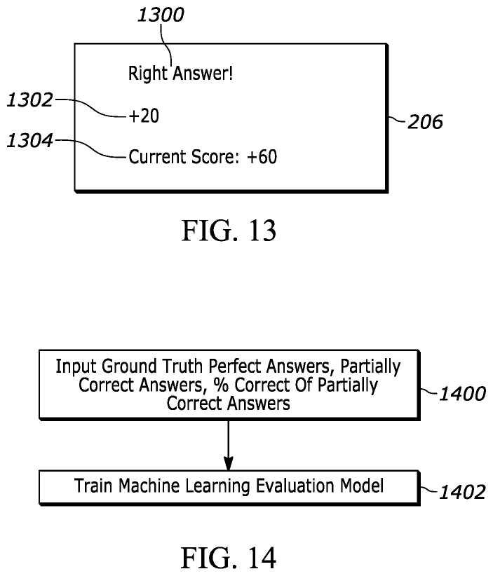

On the other hand, FIG. 13 illustrates that a remote player entering a correct response to an objective is informed of such at 1300. A reward 1302 may be awarded and the player's current overall score 1304 updated.

Note that in addition to evaluating an answer for objective correctness, if the answer is spoken it may be evaluated for correct pronunciation and scored accordingly. If an incorrect pronunciation was used, the ML model may play back on the speakers 212 the correct pronunciation.

FIG. 14 illustrates example logic for training the ML evaluation model 220 in FIG. 2. At state 1400 a training set of data is input to the model to train the model at state 1402. The training set may include pairs of completely correct and partially correct responses with ground truth indication of the degree of correctness of the partially correct responses.

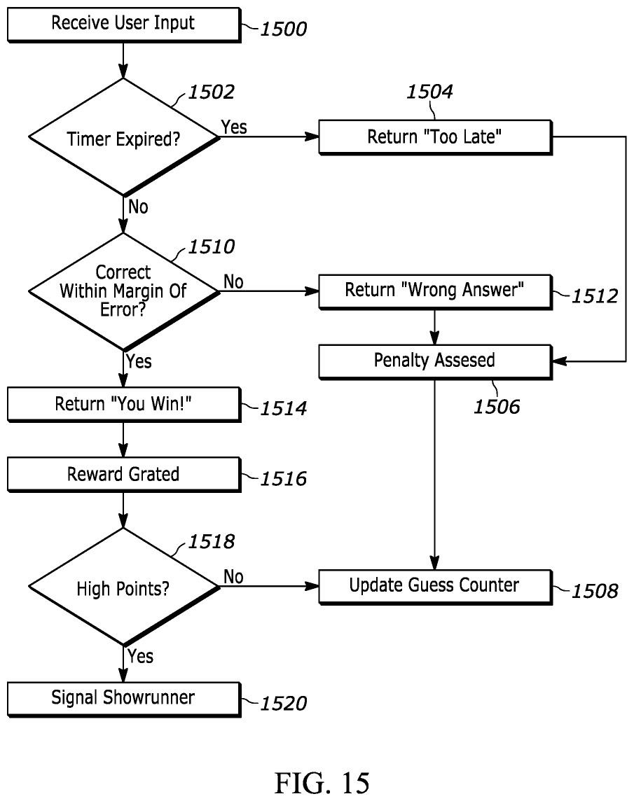

FIG. 15 illustrates aspects of present principles embodied in the app 218 of FIG. 2 in flow chart format. Commencing at state 1500, the player's response is received. When a timer is used, if it is determined to have expired at state 1502, the UI of 1100 may be presented at state 1504 and a penalty assessed if desired at state 1506. The remote player device signals to the cloud-based backend the results to update the overall score of the player in the system and to update the guess counter, if one is implemented.

On the other hand, if the player beat the timer but the response is determined to be incorrect at state 1510, the logic moves to state 1512 to present the UI in FIG. 12. Penalties and guess counters may be updated.

In contrast, if the player correctly responded within the time period for response, the logic may present the UI of FIG. 13 at state 1514. An award may be implemented at state 1516. If the total amount of points awarded the player is determined to exceed a threshold at state 1518, the showrunner is notified at state 1520 such as by lighting the lamp 220 in FIG. 2 and sending player information to the showrunner for possible appearance as a future contestant. This benefits showrunners by identifying which viewers at home are exceptionally good at playing the game. The showrunner can then use this data to identify future players to invite to play on the show.

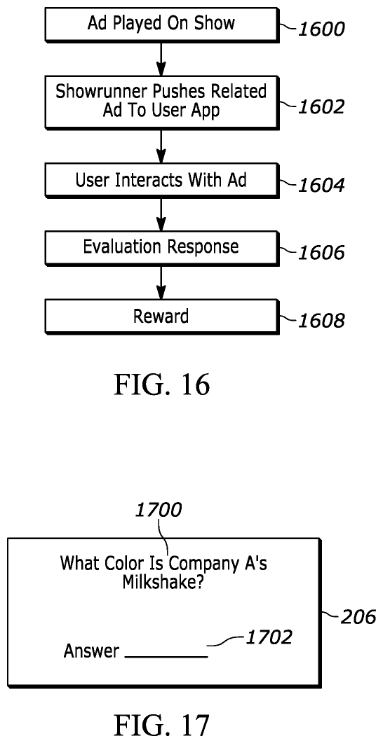

Although game shows are one example of linear media that can be improved using present principles, other examples are contemplated. FIG. 16 illustrates. Assume an ad is played in a linear media show at state 1600. The showrunner source 200 may use a prompting API to push a matching ad to the app 218 at state 1602. That ad may be interactive, so that the viewer can interact with the ad at state 1604 such as by buying the item from the ad by clicking on the item. Alternatively, the ad may contain its own objective (e.g. a mini-game) that the viewer can play. For example, as shown in FIG. 17 an ad presented by the app 218 may have a question 1700 like “What color is a milkshake” The viewer's response input to response field 1702 can be passed up to the backend system, which can then use correct and incorrect responses at state 1606 of FIG. 16 to gauge interest and awareness of the product being advertised and accord awards at state 1608 if desired, such as product or service coupons.

The linear media may be a linear narrative such as a movie or TV show, where the viewer prompting API pushes trivia questions about what's happening in the show to viewers' mobile apps. Yet again, the linear media may be a live podcast or radio broadcast that could push a contest to listeners, such as “the first listener to guess this song based on its first three seconds wins tickets to see a concert at the stadium.” That objective could be pushed to listeners' apps, and their responses-along with their response time—can be sent back to the response evaluation system to determine who wins the tickets.

The remote player can play against himself and simply track his score against the show contestants. Or, the remote player may be a remote contestant. The score of the remote player may be placed within a quartile or other division of remote players and presented, so the remote player knows how well he is doing.

The app 218 may execute an announcer ML model that celebrates wins at home with the player by speaking encouraging words to be played on the speakers 212. Indeed the app 218 may replace show audio with a customized audio and place an image of the remote player in the AV content.

While the particular embodiments are herein shown and described in detail, it is to be understood that the subject matter which is encompassed by the present invention is limited only by the claims.

What is claimed is:

1. A method comprising:
receiving linear media in the form of a game show;
receiving metadata with the linear media;
using the metadata, presenting at least one objective on a remote player device;
receiving a response to the objective;
based on the response being correct, presenting a first indication on the remote player device; and
based on the response being incorrect, presenting a second indication on the remote player device.

2. The method of claim 1, comprising determining whether the response is correct based at least in part on a timer.

3. The method of claim 1, comprising determining whether the response is correct based at least in part on the response matching a ground truth response contained in the metadata.

4. The method of claim 1, comprising determining whether the response is correct based at least in part on a timer and based at least in part on the response matching a ground truth response contained in the metadata.

5. The method of claim 3, comprising executing at least one machine learning (ML) model to determine whether the response matches the ground truth response contained in the metadata.

6. The method of claim 1, comprising presenting the linear media on the remote player device.

7. The method of claim 6, comprising synchronizing presentation of the linear media on the remote player device with presentation of the objective, such that the objective is presented at the same time in the linear media and on the remote player device.

8. The method of claim 1, comprising assessing a penalty responsive to a determination that the response is incorrect.

9. The method of claim 1, comprising awarding a reward responsive to a determination that the response is correct.

10. The method of claim 1, comprising notifying a showrunner sourcing the linear media of play input via the remote player device.

11. The method of claim 1, comprising executing the method using at least one computer system.

12. A processor system configured to:
present a live or prerecorded game show on at least one remote player device;
present on the remote player device at least one objective of the game show as the objective is being presented in the game show;
receive a response to the objective at the remote player device;
using criteria used in the remote game show, determine whether the response is correct; and
present an indication on the remote player device consistent with the determination of whether the response is correct.

13. The processor system of claim 12, wherein the processor system is configured to:
determine whether the response is correct based at least in part on a timer.

14. The processor system of claim 12, wherein the processor system is configured to:
determine whether the response is correct based at least in part on the response matching a ground truth response contained in metadata accompanying the game show.

15. The processor system of claim 14, wherein the processor system is configured to:
execute at least one machine learning (ML) model to determine whether the response matches the ground truth response contained in the metadata.

16. The processor system of claim 12, wherein the processor system is configured to:
synchronize presentation of the game show on the remote player device with presentation of the objective, such that the objective is presented at the same time in the game show and on the remote player device.

17. The processor system of claim 12, wherein the processor system is configured to:
assess a penalty responsive to a determination that the response is incorrect.

18. The processor system of claim 12, wherein the processor system is configured to:
award a reward responsive to a determination that the response is correct.

19. A device comprising:
at least one computer memory that is not a transitory signal and that comprises instructions executable by at least one processor system for:
receiving linear media;
receiving metadata with the linear media; and
using the metadata, presenting information on a display of a remote player device allowing a user of the remote player device to interact with the linear media.

20. The device of claim 19, wherein the linear media comprises a game show.
